(19) United States
(12) Patent Application Publication
(10) Pub. No.: US 2002/0053392 A1
(43) Pub. Date: May 9, 2002

(54) ADHESIVE TAPE FOR COVERING LONGITUDINALLY EXTENDED PRODUCTS SUCH AS LOOMS OF CABLES, PLASTIC PROFILED SECTIONS OR THE LIKE

(76) Inventor: CHRISTOPH LODDE, DORTMUND (DE)

Correspondence Address: ROGER T FROST, JONES & ASKEW, 3424 PEACHTREE ROAD NE, 2400 MONARCH TOWER, ATLANTA, GA, 30326, US

(21) Appl. No.: 09/485,047

(22) PCT Filed: Jun. 16, 1998
(86) PCT No.: PCT/EP98/03623

(30) Foreign Application Priority Data
Jul. 31, 1997 (DE) 197 32 958.6

(51) Int. Cl. B65C 1/00

(52) U.S. Cl. 156/213

(57) ABSTRACT

The invention relates to an adhesive tape for covering longitudinally extended products (C) such as looms of cables, plastic profiled sections or the like, comprising a strip like support (1a, 1b) defined on two sides by two side edges (3a, 3b) and provided on at least one side with a self-adhesive layer (2a, 2b) consisting of a pressure-sensitive mass which has a chemical composition such that a homogenous pressure-sensitive mass is formed in the presence of a light contact pressure (p) exerted on two adhesive layers (2a, 2b) lying on top of each other and by eliminating the contact surfaces to obtain total coalescence of the adhesive layers (2a, 2b).

The invention under consideration concerns an adhesive tape for covering longitudinally extended products, such as looms of cables, plastic profiled sections or the like, with a strip-like carrier bounded by two lateral edges, which is provided, at least on one side, with a self-adhesive layer, which consists of an adhesive agent.

A known adhesive tape of this type is, for example, described in German Utility Patent No. 94 01 037 U1. In this adhesive tape, the carrier consists of a nonwoven material, whereas the adhesive layer can advantageously consist of a pressure-sensitive adhesive agent. The adhesive tape has proven good in actual practice, in particular, in the covering of looms of cables in motor vehicles, since a foam sheath is not needed to attain an excellent cushioning effect to prevent rattling noises, and the adhesive tape can easily be removed from the roll without using an interliner. To do the covering, the adhesive tape is rolled around a loom of cables in a spiral.

The adhesive agents that are extensively used for adhesive tapes are viscoelastic adhesives that have a permanent adhesive capacity at room temperature, in solvent-free form, and with a slight contact pressure adhere to almost all substrates. As a rule, they are applied as a solution or dispersion on a carrier material. As is known, the following substances are especially used as base polymers of modern adhesive agents: natural and synthetic rubbers, polyacrylates, polyesters, polychloroprenes, polyisobutenes, such as cis-polyisoprene, polyvinyl ethers, and polyurethanes in combination with additives, such as resins, plasticizers, and oxidation inhibitors (see Römpp's Chemistry Lexicon, 9th Edition, Editors: J. Falbe, M. Regitz; Stuttgart—New York 1995, Vol. 3, p. 1704).

For the characteristics of the adhesive compound formed, such as for the strength or the elongation behavior of the adhesive films, the important influence variables are the interfaces or—if, as in most cases, we are dealing with the interface with air—the surface tensions or energies of the adhesive and of the surfaces to be cemented, which are in a causal interrelation with the pertinent structure and perhaps with the existing polarity of the constituents of the adhesive agent in the adhesive layer and the surfaces to be cemented.

For the formation of an adhesive bonding, the adhesion that occurs, which can be described quantitatively by the adhesion energy, plays the most outstanding role. In accordance with DIN 53,900, “free adhesion energy” is understood to mean the work expended for the separation of two phases, carried out isothermally and reversibly. It is equal to the sum of the free wetting energy and the free surface energy. The adhesion energy is thus determined by, among other things, the chemical nature of the surface, for example, by the molecular weight of the material of which it consists, by its density and compressibility, by the temperature, and by the presence of electrical charges, caused, for example, by polar and nonpolar fractions in the molecular structure. The adhesion energy is in close interrelation both with the viscosity as well as—according to the Gibb-Thomson equation—with the chemical potential of the surface. It is a specific, volume-related variable with the dimension of a pressure.

The goal of the invention under consideration is to create an adhesive tape of the type mentioned in the beginning and a corresponding method for covering longitudinally extended products, such as looms of cables, plastic profiled sections or the like, with an adhesive tape, which guarantees a firm adhesive bonding with material-economically favorable use of adhesive tape and a covering process of longitudinally extended products in a simple execution.

This goal is attained with an adhesive tape of the type mentioned in the beginning, in which the adhesive agent has such a chemical composition that with the existence of a slight contact pressure on two self-adhesive layers lying on one another, with a dissolution of the interfaces and a complete coalescence of the adhesive layers, a homogeneous adhesive agent mass is formed.

The method in accordance with the invention is characterized in that the longitudinally extended products are placed, in the longitudinal direction, on a section of the adhesive tape on a side of a strip-shaped carrier of the adhesive tape, provided with a self-adhesive layer, and subsequently, the adhesive tape is cemented in such a way that at least two adhesive areas of the strip-shaped carrier are cemented, against one another, on the side provided with the adhesive layer in such a way that with the dissolution of the interfaces of the adhesive layer, a homogeneous mass is formed.

Advantageously and in accordance with the invention, two self-adhesive layers, which consist of an adhesive agent and are adjacent to one another, are cemented to one another. Since the adhesive union which arises in this way involves similar adhering units, one speaks of the appearance of an auto-adhesion in this case. By means of the chemical composition of the adhesive agent selected in accordance with the invention, this auto-adhesive union is, however, immediately converted into a cohesive union of the adhesive layers with the existence of a slight contact pressure. The adhesive layers found on the strip-shaped carrier “bond,” to a certain extent, with one another. This “self-bonding” can be understood as an intensive micromechanical interlocking on a molecular level. In this process, the former interfaces dissolve and a homogeneous mass is formed from the joined-together adhesive surfaces. Thus, an optimal firm adhesive union arises by means of the longitudinal cementing technique, in accordance with the invention, entailing considerable processing advantages. As a result of the complete coalescence of the adhesive layer, a separation attempt always results in a rupture in the cohesion.

As pointed out above, this behavior is correlated with the chemical nature of the surface, like the molecular weight, polar and nonpolar fractions in the molecular structure, and the chemical potential, with physical characteristics, such as density, viscosity, and compressibility, and with integral system variables, such as the temperature.

By a purposeful selection of the adhesive, such a level of the free adhesion energy with such a ratio of the free wetting energy to the free surface energy of the adhesive agent is attained in the self-adhesive layer, in accordance with the invention, that the adhesive of the adhesive tape suitable for longitudinal cementing in a special manner is pressure-sensitive and has a very rapidly occurring “self-bonding” effect.

Such an adhesive agent for the adhesive layer can advantageously contain a natural or a synthetic rubber.

Primarily, an adhesive agent which contains a butyl rubber (IIR) and/or isoprene rubber (IR) and/or polyisobutene (IM), a styrene-containing copolymer, and a natural or hydrocarbon resin component, and base components, meets these criteria.

Other advantageous embodiments of the invention are contained in the subclaims and the special description below.

With the aid of two exemplified embodiments depicted in the appended drawings, the invention is explained in more detail. The figures show the following:

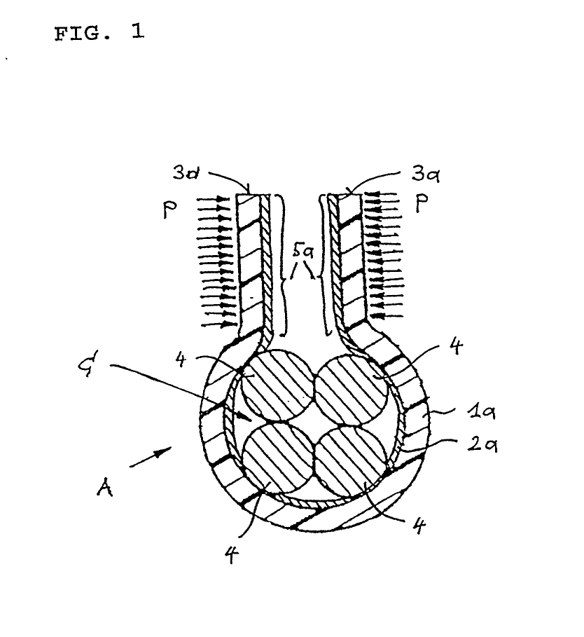

FIG. 1: a section of a first exemplified embodiment of an adhesive tape, in accordance with the invention, for the covering of longitudinally extended products with a loom of cables placed in between, in cross section and in an enlarged view;

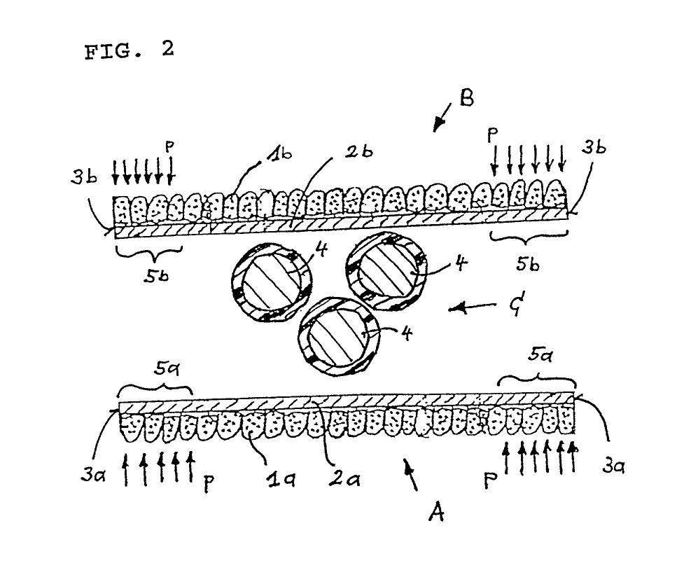

FIG. 2: two sections of a second exemplified embodiment of an adhesive tape, in accordance with the invention, for the covering of longitudinally extended products with a loom of cables placed in between, in cross section and in an enlarged view.

As can be seen from FIGS. 1 and 2, an adhesive tape in accordance with the invention, of which one section A is depicted in FIG. 1 and two sections A and B in FIG. 2, has a strip-shaped carrier 1a, 1b, which is provided with an adhesive layer 2a, 2b on one side. The carrier 1a, 1b is bounded by two lateral edges 3a, 3b. The adhesive layer 2a, 2b consists of a rubber-containing adhesive agent.

The selected reference symbols of the two sections A, B of the adhesive tape contain the same number component for parts which are the same or correspond to one another, and the letter addition “a” for the first section A and the addition “b” for the second section B.

In FIG. 1, section A covers the longitudinally extended product C, which is positioned on it and which, in the first example, is a loom of cables, consisting of four cables 4. Two sections of the cable layer 2a, which lie in the area of the lateral edges 3a and which are intended to form an adhesive area 5a on the tape-shaped carrier, face one another.

FIG. 2 shows the first section A of the adhesive tape lying under the longitudinally extended product C, which, in the second example, is a loom of cables, consisting of three cables 4. The second section B of the adhesive tape is placed over the loom of cables. The two sections A, B of the adhesive tape are placed in such a way that the individual sides with the adhesive layer 2a, 2b face one another.

In both embodiments of the adhesive tape, the adhesive agent has such a chemical composition that with the existence of a slight contact pressure (in the direction of the arrows p in FIGS. 1 and 2), if the adhesive layers 2a, 2b lie on one another, a homogeneous adhesive agent mass is formed, with the dissolution of the interfaces and a complete coalescence of the adhesive layers 2a, 2b.

Preferably, the adhesive agent can contain butyl rubber (IIR) and/or isoprene rubber (IR), and/or polyisobutene (IM), a styrene-containing copolymer, and a natural or hydrocarbon resin component as base components.

The styrene-containing component can advantageously be a styrene-isoprene rubber (SIR), in particular an SIS block copolymer, with a styrene content of 15-30 percent. The SIS block copolymer with its polar aromatic groups, which produce a decline in the loopings in the rubber chain by steric hindrance and reinforce the formation of intermolecular interactions, contributes in a special way to the increase in adhesion capacity and to the strength of the adhesive bonding.

The rubber can advantageously have an average relative molecular weight in the range of 20,000-3,000,000 and be present, in particular, in two fractions with different ranges of the molecular weight.

The natural or hydrocarbon resin component should preferably have a softening point in the range of 80-105° C.

To reduce an oxidation of the adhesive layer 2a, 2b, the adhesive agent can also contain antioxidants, which are produced, in particular, on the basis of alkylated phenols.

The following adhesive recipe has proven particularly suitable with respect to these features:

| Component | Weight content |
|---|---|
| SIS Block copolymer with 15-30% | 20-80 |
| styrene content | |
| Butyl rubber with an average molecular | 20-80 |
| weight of 300,000-3,000,000 | |
| Butyl rubber with an average molecular | 0-20 |
| weight of 20,000-60,000 | |
| Hydrocarbon resin or colophony ester | 40-100 |
| resin with a softening point 80-105° C. | |
| Antioxidants based on alkylated phenols | 1-5 |
| Fillers | 10-80 |
| Flameproofing agent | 0-60 |

As fillers, one can use, for example, calcium carbonate, chalk or kaolin, with a suitable granulometric composition.

Flameproofing agents can, for example, consist of halogen-containing substances, such as chloroparaffins or brominated phenyl oxides, in combination with a synergist, such as antimony trioxide, or halogen-free substances, such as ammonium polyphosphates, magnesium hydroxides, aluminum hydroxides, or also phosphoric acid esters. Various substances can be used in combination.

A recipe corresponding to the table below is regarded as a preferred recipe for the adhesive agent.

| Component | Weight content |
|---|---|
| SIS Block copolymer with 15-30% | 40-60 |
| styrene content | |
| Butyl rubber with an average molecular | 10 |
| weight of 300,000-3,000,000 | |
| Butyl rubber with an average molecular | 30-50 |
| weight of 20,000-60,000 | |
| Hydrocarbon resin or colophony ester | 60-100 |
| resin with a softening point of 80-105° C. | |
| Antioxidants based on alkylated phenols | 2-4 |
| Fillers | 40-60 |

Depending on the requirements profile, for example, in the automobile industry, other advantages can be attained with different combinations of diverse carriers 1a, 1b and adhesive layers 2a, 2b with the adhesive tape, in accordance with the invention; examples of these advantages are temperature resistances of at least −40° C. to +120° C., preferably −40° C. to +90° C., for a stress period of ca. 100-20,000 h, preferably 1500-3000 h. So as to guarantee a sufficient “bonding” of the adhesive layer 2a, 2b even at higher temperatures, the adhesive agent is applied advantageously in the adhesive layer 2a, 2b with a specific weight per unit area of approximately 120-700 g/m², preferably of approximately 150-300 g/m².

As materials for the carrier 1a, 1b, plastic films (as depicted in the first exemplified embodiment in FIG. 1), metal films, paper, nonwoven textiles, such as fleeces and webs, preferably polyester and staple rayon webs, for example, are suitable.

By use of a voluminous carrier 1a, 1b, for example, of a textile carrier 1a, 1b, such as a fleece or a foam carrier, noise-dampening characteristics can be imparted to the adhesive tape in accordance with the invention. In accordance with the second exemplified embodiment, FIG. 2 depicts, by way of example, a sewing fleece as material for the carrier 1a, 1b, which can be used advantageously, in particular, with weights per unit area >100 g/m².

Furthermore, the adhesive tape in accordance with the invention can also be used as protection against wear, if the adhesive layer 2a, 2b is applied on a carrier 1a, 1b with a high density and a high resistance to wear. Such a material is, for example, a man-made fiber fabric, which can preferably be made of polyester.

In order for certain cables 4 to be shielded also against electromagnetic radiation, it may be suitable, moreover, to use carriers 1a, 1b with special shielding characteristics.

Combinations of the aforementioned materials can also be used thereby, which are produced by extrusion, coextrusion, lamination or by other coating processes, for example, as they are common in the coating of fabrics. The adhesive agent used in accordance with the invention allows a large number of such combinations for the carrier 1a, 1b.

The adhesive layer 2a, 2b can be advantageously applied as a hot melt on the strip-shaped carrier 1a, 1b. However, other methods, such as coating with dissolved rubber adhesives or calendering rubber compositions on fabric, can also be used for the application.

FIGS. 1 and 2 also illustrate two methods for carrying out the method in accordance with the invention. For the bundling of the longitudinally extended product C, such as the looms of cables shown, with an adhesive tape in accordance with the invention, the longitudinally extended product C is positioned in a longitudinal direction on a section A (or B) of the adhesive tape on a side of a strip-shaped carrier 1a (or 1b), provided with a self-adhesive layer 2a (or 2b) and subsequently, the adhesive tape is cemented in such a way that at least two adhesive areas 5a (and/or 5b) of the strip-shaped carrier 1a (or 1b) are cemented against one another on the side provided with the adhesive layer 2a (or 2b) in such a way that a homogeneous mass is formed, with the dissolution of interfaces of the adhesive layer 2a (or 2b).

The adhesive areas 5a, 5b are preferentially cemented thereby with slight pressure p against one another. In this way, the necessary energy for the activation of the “bonding process” is applied between the surfaces of the adhesive layer 2a, 2b, next to one another.

As shown in FIG. 1, the cementing can take place using only one section A (or also B) of the adhesive tape. After the longitudinally extended product C is positioned on section A (or B), section A (or B) is whipped laterally around the product C in such a way that adhesive areas 5a (or 5b) are formed, which are lateral boundary areas of the strip-shaped carrier 1a (or 1b) of section A (or B), lying opposite one another. The width (distance between the individual edges 3a-3a or 3b-3b) of the adhesive tape should be so much larger than one dimension of the longitudinally extended product C to be covered that the lateral edges 3a (or 3b) of the strip-shaped carrier 1a (or 1b) are preferably covered with one another and section A (or B) of the adhesive tape completely covers the longitudinally extended product C. The dimension of the product C to be covered is produced, in the present case, from the number and the diameter size of the cables 4 of the loom of cables to be covered and from the relative location of the cables 4 to one another in the loom of cables.

Within the scope of the invention, it is also striking that the longitudinally extended product C is positioned, for example, mechanically, perhaps with the simultaneous folding of section A (or B) of the adhesive tape between the sections of the adhesive layer 2a facing one another.

As a second possible method variant, FIG. 2 shows the use of two sections A, B of the adhesive tape for covering the longitudinally extended product C. Accordingly, after the longitudinally extended product C is positioned in the area of the first section A of the adhesive tape, a second section B of the adhesive tape is brought onto the longitudinally extended product C with the side on which it is provided with the self-adhesive layer 2b. The width of the adhesive tape (distance between the individual edges 3a-3a or 3b-3b) is thereby so much greater than one dimension of the longitudinally extended product C to be covered that adhesive areas 5a, 5b are formed in opposite lateral boundary areas of the strip-shaped carrier 1a, 1b of the two sections A, B and an adhesive area 5a of the first section A is cemented against an adhesive area 5b of the second section, wherein the lateral edges 3a of the strip-shaped carrier 1a of the first section A are preferably covered with the lateral edges 3b of the strip-shaped carrier 1b of the second section B and completely cover the two sections A, B of the adhesive tape of the longitudinally extended product C.

Of course, when using both sections A and B of the adhesive tape shown, it is conversely also possible to place the longitudinally extended product C on the (second) section B, depicted in FIG. 2 above, first and to cement it then, in the manner described in the preceding, with the lower (first) section A. Likewise, within the scope of the invention, it is surprising if the two sections A, B are brought together, for example, mechanically, with one another and with the longitudinally extended product C almost simultaneously.

The adhesive tape, in accordance with the invention, is predestined, in an excellent way, for this longitudinal cementing technique, with which, with an economical use of material, a shortening of the time needed for the bundling of the longitudinally extended product can be attained.

The invention, however, is not limited to the described exemplified embodiment. Thus, the method of the invention can also be carried out with an adhesive tape whose adhesive recipe differs from the one described above as being especially suited. For example, the adhesive layer 2a, 2b also does not have to be an adhesive agent which contains rubber.

Furthermore, one should mention that the adhesive layer 2a, 2b can be applied on both sides of the strip-shaped carrier 1a, 1b. In this way, during the covering (tying with tape, bundling) of longitudinally extended product C, a “self-bonding”—of the internal and external layers of the adhesive tape—can also be attained with a conventional spiral-like winding of the adhesive tape, wherein a cementing bond is formed, which is characterized by an increased strength, in comparison with traditional adhesive tapes.

Reference Symbols

Reference symbols

| | |
|---|---|
| 1a | Carrier (section A) |
| 1b | Carrier (section B) |
| 2a | Adhesive layer (section A) |
| 2b | Adhesive layer (section B) |
| 3a | Edge of 1a |
| 3b | Edge of 1b |
| 4 | Cable (of C) |
| 5a | Adhesive area (in section A) |
| 5b | Adhesive area (in section B) |
| A | First section of the adhesive tape |
| B | Second section of the adhesive tape |
| C | Longitudinally extended products (cable harness) |
| p | Contact pressure |

1. Adhesive tape for covering longitudinally extended products (C), such as looms of cables, plastic profiled sections or the like, with a strip-shaped carrier (1a, 1b) bounded by two lateral edges (3a, 3b), which is provided, at least on one side, with a self-adhesive layer (2a, 2b), which consists of an adhesive agent, characterized in that the adhesive agent has such a chemical composition that, with the existence of a slight contact pressure (p) on two adhesive layers (2a, 2b) lying on one another, with a dissolution of the interfaces and a complete coalescence of the adhesive layers (2a, 2b), a homogeneous adhesive agent mass is formed.

2. Adhesive tape according to claim 1, characterized in that the adhesive agent contains a natural or synthetic rubber.

3. Adhesive tape according to claim 1 or 2, characterized in that the adhesive agent contains a butyl rubber (IIR) and/or isoprene rubber (IR), and/or polyisobutene (IM), a styrene-containing copolymer and a natural or hydrocarbon resin component as base components.

4. Adhesive tape according to claim 3, characterized in that the styrene-containing copolymer is a styrene-isoprene rubber (SIR), in particular, an SIS block copolymer with a styrene content of 15-30%.

5. Adhesive tape according to one of claims 1-4, characterized in that the rubber has an average relative molecular weight in the range of 20,000-3,000,000.

6. Adhesive tape according to one of claims 3-5, characterized in that the natural or hydrocarbon resin component has a softening point in the range of 80-105° C.

7. Adhesive tape according to one of claims 1-6, characterized in that the adhesive agent contains antioxidants, preferably on the basis of alkylated phenols.

8. Adhesive tape according to one of claims 1-7, characterized in that the adhesive agent contains fillers, such as calcium carbonate, chalk, or kaolin.

9. Adhesive tape according to one of claims 1-8, characterized in that the adhesive agent contains 20-80 weight fractions of an SIS block copolymer with 15-30% styrene content; 20-80 weight fractions of a butyl rubber with an average relative molecular weight of 300,000-3,000,000; 0-20 weight fractions of a butyl rubber with an average relative molecular weight of 20,000-60,000; 40-100 weight fractions of a hydrocarbon or colophony ester resin with a softening point in the range of 80-105° C.; 1-5 weight fractions of antioxidants; 10-80 weight fractions of fillers; and up to 60 weight fractions of a flameproofing agent.

10. Adhesive tape according to claims 1-9, characterized in that the adhesive agent contains 40-60 weight fractions of an SIS block copolymer with 15-30% styrene content; 30-50 weight fractions of a butyl rubber with an average relative molecular weight of 300,000 - 3,000,000; approximately 10 weight fractions of a butyl rubber with an average relative molecular weight of 20,000-60,000; 60-100 weight fractions of a hydrocarbon or colophony ester resin with a softening point in the range of 80-105°; 2-4 weight fractions of antioxidants; and 40-60 weight fractions of fillers.

11. Adhesive tape according to one of claims 1-10, characterized in that the adhesive agent is applied in the adhesive layer (2a, 2b) with a specific weight per unit area of approximately 120-700 g/m², preferably, approximately 150-300 g/m².

12. Adhesive tape according to one of claims 1-11, characterized in that the adhesive layer (2a, 2b) is applied on both sides of the strip-shaped carrier (1a, 1b).

13. Adhesive tape according to one of claims 1-12, characterized in that the strip-shaped carrier (1a, 1b) is made of plastic and/or metal film, foam, paper, a nonwoven textile, such as a fleece, and/or web, preferably a polyester and staple rayon web.

14. Adhesive tape according to one of claims 1-13, characterized in that the strip-shaped carrier (1a, 1b) is made of a sewing fleece, in particular, with a weight per unit area of more than 100 g/m².

15. Method for covering longitudinally extended products (C), such as looms of cables, plastic profiled sections or the like, with an adhesive tape, characterized in that the longitudinally extended product (C) is positioned in the longitudinal direction in the area of a section of the adhesive tape (A, B) on a side of a strip-shaped carrier (1a, 1b) of the adhesive tape, provided with a self-adhesive layer (2a, 2b) and subsequently the adhesive tape is cemented in such a way that at least two adhesive areas (5a, 5b) of the strip-shaped carrier (1a, 1b) are cemented against one another on the side provided with the adhesive layer (2a, 2b) in such a way that a homogeneous mass is formed with a dissolution of interfaces of the adhesive layer (2a, 2b).

16. Method according to claim 15, characterized in that the adhesive areas (5a, 5b) are cemented against one another with pressure (p).

17. Method according to claim 15 or 16, characterized in that, essentially, after the positioning of the longitudinally extended product (C) in the area of a section of the adhesive tape (A, B), the section (A, B) of the adhesive tape is whipped laterally around the longitudinally extended product (C) for the cementing, wherein the width (distance 3a-3a, 3b-3b) of the adhesive tape is so much larger than one dimension of the longitudinally extended product (C) to be covered that the adhesive areas (5a, 5b) are formed in lateral boundary areas of the strip-shaped carrier (1a, 1b) of the section (A, B), opposite one another, wherein the lateral edges (3a, 3b) of the strip-shaped carrier (1a, 1b) are preferably covered with one another, and the section (A, B) of the adhesive tape completely covers the longitudinally extended product (C).

18. Method according to claim 15 or 16, characterized in that, essentially, after the positioning of the longitudinally extended product (C) in the area of a section of the adhesive tape (A, B), a second section (A, B) of the adhesive tape is brought onto the longitudinally extended product (C) with its side provided with the self-adhesive layer (2b, 2a) for the cementing, and the width of the adhesive tape (distance 3b-3b, 3a-3a) is so much larger than one dimension of the longitudinally extended product (C) to be covered that the adhesive areas (5a, 5b) are formed in lateral boundary areas of the strip-shaped carrier (1a, 1b) of both sections (A, B), opposite one another, wherein an adhesive area (5a) of the first section (A) is cemented against an adhesive area (5b) of the second section (B); the lateral edges (3a) of the strip-shaped carrier (1a) of the first section (A) are preferably covered with the lateral edges (3b) of the strip-shaped carrier (1b) of the second section (B); and the two sections (A, B) of the adhesive tape completely wrap the longitudinally extended product (C).

19. Method according to one of claims 15-18, characterized by the use of an adhesive tape according to one of claims 1-14.
